(19) United States
(12) Patent Application Publication
(10) Pub. No.: US 2015/0337996 A1
(43) Pub. Date: Nov. 26, 2015

(54) FLEXIBLE HOSE

(71) Applicant: ContiTech MGW GmbH, Hannoversch-Muenden (DE)

(72) Inventors: Paul Bennett, Bramcote Nottingham (GB); Houshang Memarian, Horley Charlwood Surrey (GB); Horst Reinhard, Hauneck (DE); Dirk Stuhrmann, Hamburg (DE); Hauke Westenberg, Muenster (DE); Sebastian Seibold, Hannoversch-Muenden (DE); Michael Rajasekara, Hannoversch-Muenden (DE)

(21) Appl. No.: 14/818,641

(22) Filed: Aug. 5, 2015

Related U.S. Application Data
(63) Continuation of application No. PCT/EP2013/077269, filed on Dec. 19, 2013.

(30) Foreign Application Priority Data
Feb. 8, 2013 (EP) 13154619.4

(51) Int. Cl. F16L 11/02; F16L 11/10

(52) U.S. Cl. CPC F16L 11/02; F16L 11/10

(57) ABSTRACT

A hose, in particular a charge-air hose, having an elastomer inner layer and at least one rubberized textile layer, wherein the at least one rubberized textile layer is directly wound onto the elastomer inner layer. The elastomer inner layer may be made from a fluoropolymer. The rubberized textile layer may be a woven fabric. Further, the rubberizing material of the rubberized textile ply may be based on a silicone rubber.

### CROSS REFERENCE TO RELATED APPLICATIONS

This application is a continuation application of international patent application PCT/EP2013/077269, filed Dec. 19, 2013, designating the United States and claiming priority from European application 13154619.4, filed Feb. 8, 2013, and the entire content of both applications is incorporated herein by reference.

### FIELD OF THE INVENTION

The invention relates to a flexible hose, in particular for use as charge-air hose.

### BACKGROUND OF THE INVENTION

The connection between turbocharger and charge-air cooler (hot side), and the connection between charge-air cooler and the engine (cold side) are mostly achieved by using what are known as charge-air hoses. Both the hot side and the cold side here must withstand relatively high pressures, and must also be sufficiently flexible to compensate the relative motion between engine and charge-air cooler. Comparable requirements are also placed upon other hoses, for example industrial hoses, which likewise have to with-stand high pressures and varying temperatures.

Charge-air hoses for charge-air lines are already well known. By way of example, U.S. Pat. No. 8,997,795 discloses a charge-air and cooling-water hose which features good pressure resistance and flexibility. In this case, a second layer taking the form of a tubular knitted fabric or braided fabric is applied to a first layer taking the form of an elastomeric internal layer, and then a textile ply rubberized on both sides is wound onto the two layers.

The use of a tubular knitted fabric has the disadvantage that it has to have a certain minimum thickness in order to achieve good pressure resistance, this frequently being achieved via processing of a relatively thick yarn. However, relatively thick yarns cause adhesion problems. Alternatively a double knitted fabric is used; this frequently incurs higher costs through provision of more extruders and of suitable knitting machines. In both cases, the entire hose has increased diameter and unacceptable stiffness.

Another result of the relatively high stiffness is that it becomes difficult to produce a curved hose.

### SUMMARY OF THE INVENTION

It is therefore an object of the invention to provide a flexible hose which on the one hand features good flexibility and adequate pressure resistance, and on the other hand has a stiffness that permits production of various curved shapes. At the same time, the intention is to avoid increasing complexity in the production of the hose, and instead preferably to reduce the same.

The invention is achieved in that the hose comprises an elastomeric internal layer and at least one rubberized textile ply, where at least one rubberized textile ply has been wound directly onto the elastomeric internal layer.

Surprisingly, it has been found that this type of hose structure can achieve excellent flexibility, thus permitting production of various curved shapes. At the same time, adequate pressure resistance is moreover obtained.

### DESCRIPTION OF THE PREFERRED EMBODIMENTS OF THE INVENTION

In one particularly preferred embodiment, the hose contains an elastomeric internal layer and at least one rubberized textile ply, where the at least one rubberized textile ply has been wound onto the elastomeric internal layer. However, it is possible that there is also at least one further layer, for example in the form of a coating, on the wound rubberized textile ply.

The internal layer is preferably an extruded internal layer, which in another preferred embodiment is also resilient. The internally layer preferably comprises at least one fluoropolymer. The fluoropolymer used can comprise any of the fluoropolymers known to the person skilled in the art. However, preference is given here to polytetrafluoroethylene (PTFE), modified polytetrafluoroethylene (TFM), fluoroethylenepolymer (FEP), perfluorinated alkyl vinylether-tetrafluoroethylene copolymer (PFA) or ethylene-tetrafluoroethylene copolymer (ETFE). It is equally possible to use copolymers such as poly(vinylidene fluoride-co-hexafluoro-propylene) (VDF/HFP), poly(vinylidene fluoride-co-hexafluoropropylene-co-tetrafluoroethylene) (TFB), poly(vinylidene fluoride-co-tetrafluoroethylene-co-perfluorinated methyl vinyl ether) (VDF/TFE/PMVE), poly(tetrafluoroethylene-co-propylene) (TFE/P), and poly(vinylidene fluoride-co-chlorotrifluoroethylene) (VDF/CTFE), or fluorosilicone rubber (FVMQ), or else terpolymers based on VDF/HFP/TFE. The internal layer here can take the form of fluoropolymer mixture, that is, a polymer mixture which can also comprise, alongside at least one fluoropolymer, other constituents such as fillers, plasticizers, et cetera.

However, it is particularly preferable that the internal layer consists of a fluoropolymer, in particular of PTFE, which advantageously takes the form of seamlessly extruded film.

The rubberized textile ply has preferably been rubberized on both sides, but single-side rubberization is also possible here for certain application sectors.

The rubberizing material itself here is based on at least one rubber component. Particular rubber components that may be mentioned are: ethylene-propylene copolymer (EPM) and/or ethylene-propylene-diene copolymer (EPDM) and/or nitrile rubber (NBR) and/or (partially) hydrogenated nitrile rubber (HNBR) and/or fluororubber (FKM) and/or chloroprene rubber (CR) and/or natural rubber (NR) and/or styrene-butadiene rubber (SBR) and/or isoprene rubber (IR) and/or butyl rubber (IIR) and/or bromobutyl rubber (BIIR) and/or chlorobutyl rubber (CIIR) and/or butadiene rubber (BR) and/or chlorinated polyethylene (CM) and/or chlorosulfonated polyethylene (CSM) and/or polyepichlorohydrin (ECO) and/or ethylene-vinyl acetate rubber (EVA) and/or acrylate rubber (ACM) and/or ethylene-acrylate rubber (AEM) and/or silicone rubber (MQ, VMQ, PVMQ) and/or fluorosilicone rubber (FVMQ) and/or fluorinated methylsilicone rubber (MFQ) and/or perfluorinated propylene rubber (FFPM) and/or perfluorocarbon rubber (FFKM) and/or polyurethane (PU).

Silicone rubber, and in particular VMQ, has proven to be particularly suitable. Particularly good dynamic stability is found here at high temperatures.

The rubber components mentioned can be used alone or in a blend with at least one other rubber component.

However, it is also possible that a blend of rubber components with thermoplastic elastomers and/or thermoplastics is present. In principle, it is possible here to use any thermoplastic elastomer and/or thermoplastic.

The textile ply of the rubberized textile ply can be what is known as a “woven fabric”, “knitted fabric”, or “nonwoven fabric”.

The expression “woven fabric” is usually used for woven fabrics in which the textile ply is produced via intersection of two filament systems, namely warp and weft. The expression “knitted fabric” is usually used for knitted fabrics in which a loop formed by a filament has been inserted into another loop. The knitted fabrics thus produced can be formed by using single or multiple filaments.

The expression “nonwoven fabric” is mostly used for webs, felts, or wadding, in which the fibers are held together by their intrinsic adhesion.

The textile ply is advantageously a woven fabric which has been calendered together with the rubberizing material.

Woven fabric plies generally give better results in calendering together with the rubberizing material. An additional increase of pressure resistance can be achieved via thicker individual filaments in the woven fabric, or by multiple winding of the calendered woven-fabric sheet around the internal layer. In contrast to the extruded plies mentioned in the introduction consisting entirely of knitted fabric, there is no additional capital expenditure for additional machinery required, and the wall thickness of the entire hose is increased to a less significant extent by the calendering process than by the extrusion process.

The distance between the woven fabric layers is also significantly smaller than in the case of a double knitted fabric.

Materials that can be used for the textile ply are any of the materials known to the person skilled in the art. Examples of those that can be used are polyamide (PA), for example, PA6, PA6.6, PA11, PA12, PA6.10, PA6.12, polyimide (PI), aramid, in particular para-aramid or meta-aramid, polyvinyl acetal (PVA), polyvinyl alcohol (PVAL), polyetheretherketone (PEEK), polyester, in particular polyethylene terephthalate (PET), or polyethylene 2,6 naphthalate (PEN), polysulfone (PSU), polyoxadiazole (POD), polyphenylene, or polyphenylene derivative, for example polyphenylene sulfide (PPS), or polyphenylene oxide (PPO), polybenzoxazole (PBO), cotton, basalt, metal, carbon, wool, staple viscose, sisal, hemp, flax, rayon, or other natural fibers, or glass fibers. Hybrid systems can also be used, that is, mixed forms of the systems mentioned, for example in the form of a thread made of a mixture of m- and p-aramid, or made of PPS and PA. PPS is a high-performance material that contributes to high strength, while PA has not only a reinforcing effect but also, because it can be activated to provide adhesion, contributes to improved adhesion in relation to the rubberizing material.

The rubberized textile ply can have been wound with abutted edges or with overlap.

It is preferable that the rubberized textile ply has been wound with overlap. Although this leads to greater wall thickness in the overlap region, it exhibits significant advantages in relation to durability.

The ply can have been single- or multiple-wound around the internal layer, in accordance with pressure requirement. It has preferably been wound circumferentially or helically at a defined angle around the internal layer.

### BRIEF DESCRIPTION OF THE DRAWINGS

The invention will now be described with reference to the drawings wherein:

FIG. 1 is a diagram of the structure of a charge-air hose 10; and,

FIG. 2 is a longitudinal section through a charge-air hose 20.

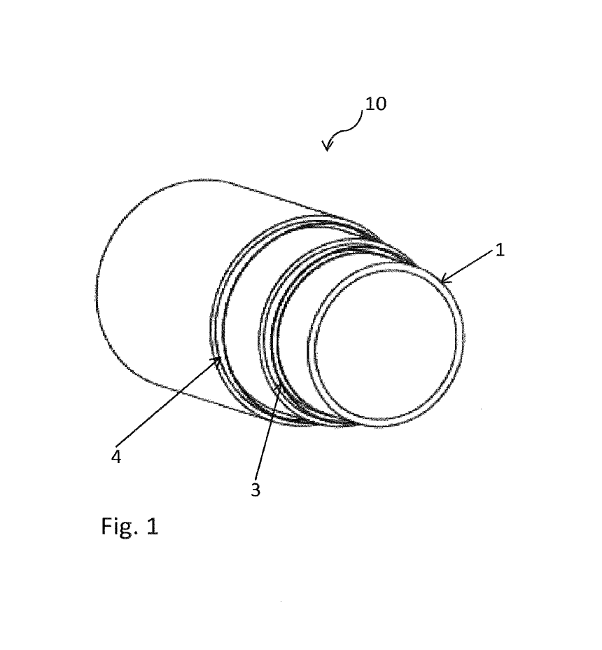

FIG. 1 is a diagram of the structure of a charge-air hose 10 with an internal layer 1 made of a seamlessly extruded PTFE film and a first rubberized textile ply 3 which has been wound directly onto the internal layer 1, and a second rubberized textile ply 4 which has been wound onto the first rubberized textile ply. The rubberized textile plies (3, 4) have been calendered, and consist of VMQ and m-aramid.

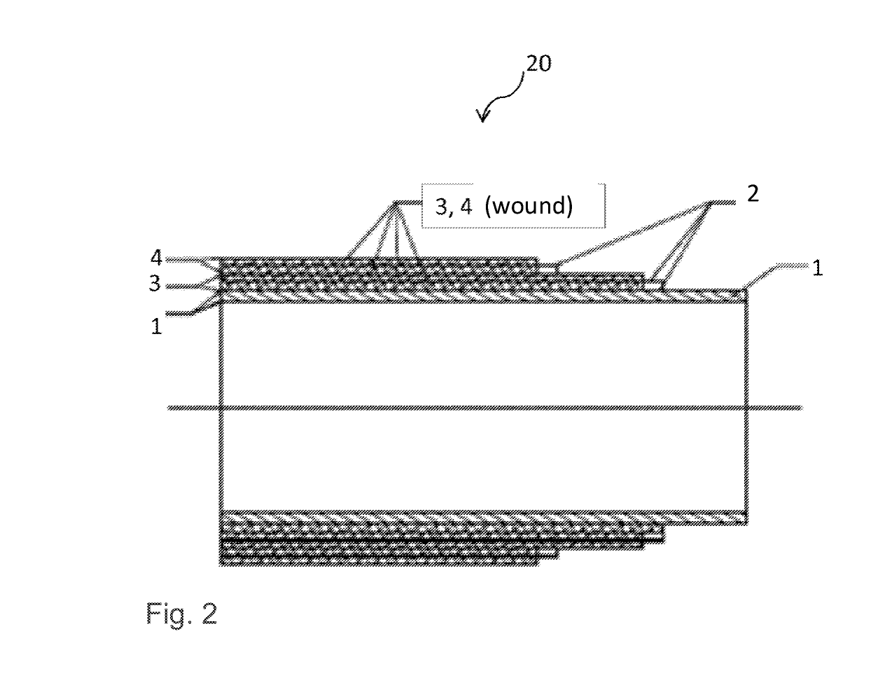

FIG. 2 is a longitudinal section through a charge-air hose 20. The first rubberized textile ply 3 has been double-wound directly onto the internal layer 1, while the second rubberized textile ply 4 has been single-wound onto the first rubberized textile ply 3. This longitudinal section also depicts the textile plies 2 of the rubberized textile plies (3, 4).

It is understood that the foregoing description is that of the preferred embodiments of the invention and that various changes and modifications may be made thereto without departing from the spirit and scope of the invention as defined in the appended claims.

### KEY (PART OF THE DESCRIPTION)

10, 20 Hose, preferably charge-air hose
1 Internal layer
2 Textile ply, preferably woven fabric, of the rubberized textile plies
3 First rubberized textile ply, wound
4 Second rubberized textile ply, wound

What is claimed is:

1. A hose comprising:
an elastomeric internal layer; and,
at least one rubberized textile ply,
wherein the at least one rubberized textile ply has been wound directly onto the elastomeric internal layer.

2. The hose as claimed in claim 1, wherein the elastomeric internal layer comprises at least one fluoropolymer.

3. The hose as claimed in claim 1, wherein the elastomeric internal layer consists of the at least one fluoropolymer.

4. The hose as claimed in claim 3, wherein the elastomeric internal layer consists of PTFE.

5. The hose as claimed in claim 1, wherein the elastomeric internal layer is a seamlessly extruded PTFE film.

6. The hose as claimed in claim 1, wherein the rubberized textile ply is a woven fabric.

7. The hose as claimed in claim 1, wherein the rubberizing material of the rubberized textile ply is based on a silicone rubber.

8. The hose as claimed in claim 1, wherein the hose is a charge-air hose.
